(19) United States
(12) Patent Application Publication
(10) Pub. No.: US 2006/0048553 A1
(43) Pub. Date: Mar. 9, 2006

(54) Lead-free keys and alloys thereof

(75) Inventor: Scott B. Almquist, Sioux Falls, SD (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Keyworks, Inc., Sioux Falls, SD (US)

(21) Appl. No.: 11/189,267

(22) Filed: Jul. 26, 2005

Related U.S. Application Data
(60) Provisional application No. 60/607,128, filed on Sep. 3, 2004.

(51) Int. Cl. E05B 19/02

(52) U.S. Cl. 70/406

(57) ABSTRACT

The present invention is a key that includes a key head and a key blade, the key blade being connected to the key head. The key head and the key blade are each manufactured from an alloy that includes at least about 70% by weight copper, where the alloy includes less than about 6.0% by weight nickel, and is substantially free of lead.

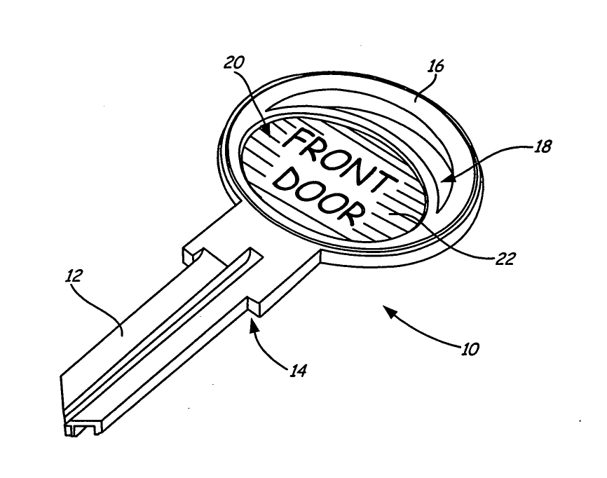

### CROSS-REFERENCE TO RELATED APPLICATION(S)

Priority is claimed from U.S. Provisional Patent Application No. 60/607,128, entitled “Improved Key Design”, filed on Sep. 3, 2004, and which is incorporated by reference in its entirety.

### BACKGROUND OF THE INVENTION

The present invention relates to keys, such as keys for residential, commercial, and automotive key locks. In particular, the present invention relates to keys that are derived from machinable alloys that are substantially free of lead and contain low concentrations of nickel.

For the better part of the last century, keys have typically been wrought and milled from leaded brass and nickel alloys. Such processes are generally the most efficient and economical forms of manufacturing keys. However, the processes do not address the issues of consumer health or the additional consumer-oriented needs of ergonomics, identification, and ornamentation.

Previous attempts to address these consumer needs involved only the use of stamped leaded brass or leaded nickel keys. However, stamping produces keys that are small and unmanageable for many individuals. Moreover, stamped keys are also generally manufactured with similar shapes and sizes, which makes identifying keys by touch difficult due to indistinct borders or textured surfaces.

Even though stamped brass and nickel silver keys, or wrought keys, have achieved significant popularity and commercial success, they exhibit several drawbacks. For example, keys containing lead and nickel exhibit potential health hazards. Additionally, such keys are typically constrained to indistinguishable shapes. Thus, there is a need for keys that are substantially free of hazardous materials as well as keys that exhibit improved ergonomics and identification.

### BRIEF SUMMARY OF THE INVENTION

The present invention is a key, which includes a key head and a key blade, where the key blade is connected to the key head. The key head and the key blade are each manufactured from an alloy that comprises at least about 70% by weight copper, where the alloy includes less than about 6.0% by weight nickel and is substantially free of lead.

### BRIEF DESCRIPTION OF THE DRAWINGS

The figure is a top perspective view of a key of the present invention.

While the above-identified drawing figure sets forth an embodiment of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figure may not be drawn to scale.

### DETAILED DESCRIPTION

The figure is a top perspective view of key 10 of the present invention, which is a key that is substantially free of lead, contains a low concentration of nickel, and is ergonomical and identifiable. Key 10 includes key blade 12, shoulder 14, and key head 16, where key blade 12 is integrally connected to key head 16 at shoulder 14. Key blade 12 includes millings or grooves, which correspond to the shape of a key receptacle in a particular lock (e.g., residential, commercial, and automotive key locks). Shoulder 14 acts as an aligning mechanism for duplication of key 10.

Key head 16 is a gripping portion of key 10, and includes aperture 18 and indentation 20. Aperture 18 is an opening through key head 16 for retaining key 10 on a key ring. Indentation 20 is a bordered indented portion of key head 16, which contains label 22. As discussed below, key head 16 may be manufactured to meet ergonomic standards and to be distinguished from other key heads (i.e., identifiable).

Key blade 12 and key head 16 of key 10 are each derived from an alloy that includes less than about 6.0% by weight nickel (Ni) and is substantially free of lead (Pb). Traditional leaded-brass and leaded-nickel-silver keys are considered potential sources for (1) lead exposure and (2) nickel allergic contact dermatitis. Lead is typically used in traditional key alloys to enhance machinability. However, trace amounts of lead may leach from a traditional key to the hands of a user. The lead may then enter the body through key-to-mouth or hand-to-mouth activity. This is particularly true for children and pets, which are oftentimes allowed to play with keys. Prolonged lead exposure may adversely affect the central nervous system, kidneys, and blood cells, which may potentially impair physical and mental development.

In addition to lead, nickel can also leach from certain alloys by perspiration or moisture, in which free nickel ions located on the key surface may penetrate and irritate the skin. The rate of nickel ion release to the skin depends on the specific substance contacting the skin, but once a nickel allergy has developed, the condition typically becomes chronic.

The alloy of key 10 includes primarily copper (Cu). The alloy also contains low concentrations of nickel and is substantially free of lead. Examples of suitable concentrations of nickel in the alloy include less than about 6.0% by weight. Examples of particularly suitable concentrations of nickel in the alloy include less than about 3.0% by weight. Even more particularly suitable concentrations of nickel in the alloy include less than about 0.5% by weight. All nickel concentrations are herein based on the entire weight of the alloy.

The low concentration limits on lead and nickel allow users to continuously use key 10 without worry of potential lead or nickel-based health risks. In one embodiment of the present invention, the alloy of key 10 is substantially free of both lead and nickel. An example of a suitable minimum concentration of copper in the alloy includes at least about 70% by weight. An example of a particularly suitable minimum concentration of copper in the alloy includes at least about 80% by weight. An example of an even more particularly suitable minimum concentration of copper in the alloy includes at least about 86% by weight. All copper concentrations are herein based on the entire weight of the alloy.

In addition to copper, the alloy of key 10 may also include other materials that do not represent substantial health hazards to users. Examples of suitable additional materials in the alloy include aluminum (Al), silicon (Si), iron (Fe), manganese (Mn), tin (Sn), zinc (Zn), titanium (Ti), and combinations thereof. Examples of suitable concentrations of aluminum in the alloy range from about 5% to about 15% by weight, with particularly suitable concentrations ranging from about 6% to about 8% by weight, based on the entire weight of the alloy. Examples of suitable concentrations of silicon in the alloy range from about 1.5% to about 3.5% by weight, based on the entire weight of the alloy. Examples of suitable concentrations of iron in the alloy range from about 0.5% to about 6% by weight, based on the entire weight of the alloy.

Examples of suitable commercially available alloys for key 10 include aluminum-bronze alloys under the UNS designations C95200, C95300, C95400, C95500, and C95600. Each of these commercially available alloys contain at least about 78% copper, and are substantially free of both lead and nickel.

The alloy of key 10 exhibits acceptable machinability despite being substantially free of lead. Lead exists in current commercially available key alloys at about 2% by weight to aid in machinability. Machinability is a measurement of how easily a given key may be cut for duplication. Machinability of an alloy is defined herein as a relative measurement compared to a free-machining low carbon steel, designated as 160 Brinell B1112 (B1112 standard) from the American Iron and Steel Institute (AISI), based on turning tests at 180 surface feet. The B1112 standard represents 100% machinability, and is a typical standard for measuring machinability. As such, an alloy with a machinability greater than 100% is easier to cut than the B1112 standard, and an alloy with a machinability less than 100% is more difficult to cut than the B1112 standard.

In comparison to the B1112 standard, aluminum bronze alloys under UNS C95200, C95300, and C95600, which are suitable alloys for use with key 10 of the present invention, exhibit machinabilities of about 160%. As such, the alloys of key 10 have adequate machinabilities for key duplication. Moreover, the alloy of key 10 is substantially free of lead, which is typically used to increase the machinability of alloys.

Key 10 of the present invention may be manufactured in a variety of manners. Examples of suitable manufacturing techniques include casting and metal injection molding, each of which provide key 10 with the freedom of design to improve ergonomics and identification. A particularly suitable method for manufacturing key 10 includes investment casting, also referred to as lost-wax casting. Investment casting utilizes permanent aluminum injection molds to create expendable wax pattern replicas of a design of key 10. Multiple wax patterns are gated and ganged together on a single expendable wax sprue. The sprues are then repeatedly dipped in a ceramic slurry, coated with refractory sand, and allowed to dry. The hard ceramic coating is heated, melting out the wax core, leaving an empty ceramic mold. The ceramic mold is then fired at a high temperature into which the melted alloy of key 10 is poured for casting. Once cool, the ceramic coating is removed, and each key 10 is cut from the sprue. The gates are then ground off each of keys 10 and each key 10 is ready for finishing.

Metal injection molding is a viable metal fabrication process in which fine metal powders are combined with a polymer binder system to form a feedstock suitable for injection into a permanent steel mold. Standard plastic injection molding machines and molds may be used to produce each of keys 10. However, due to the presence of the polymer binder in metal injection molding feedstocks, mold cavities are generally designed approximately 20% larger than the final size of each key 10.

Similar to plastic injection molding, metal injection molding molds may have multiple cavities, gates, hot runner systems, and inserts. After molding, each of keys 10 may be debound and sintered at temperatures up to 2,600° F. The sintering causes the given key 10 to shrink dramatically. Therefore, the appropriate shrink factor for the alloy of key 10 is considered prior to tooling. During debinding, the polymer binder breaks down and dissipates while the metal particles retain all of the molded features. These metal particles then fuse together during sintering to form each key 10. Once cool, the gates are ground off each of keys 10 and each key 10 is ready for finishing.

Investment castings and metal injection molded parts are normally shipped from the foundry “as cast”, which means each key 10 generally requires a secondary operation of vibratory finishing. Each key 10 may be individually finished based on personalized requirements, or a set of keys 10 may be mass finished. Mass finishing refers to vibrating free-flowing cast parts in a bowl that contains abrasive cone-shaped media and solutions. Once finished, the each of keys 10 is ready to be packaged for shipping. In one embodiment of the present invention, the alloys may also be heat treated.

As discussed above, key 10 exhibits a design that is ergonomic and identifiable. The ergonomic properties of key 10 address consumer capabilities, limitations, and well-being. For example, key head 16 of key 10 may be large in size compared to traditional stamped keys. Older adults, despite maintaining active and independent lifestyles, may suffer from the inconvenience of limited dexterity. Tasks normally considered insignificant often become an encumbrance, such as securing a grip on a key while turning it in a lock. To accommodate these user limitations, key head 16 of key 10 may be manufactured with to exhibit large dimensions in order to make these basic activities of daily living much less inconvenient.

Key head 16 may also be manufactured with distinctive designs, which establish an identifiable association merely by touch. When a user needs to locate a particular key on a key ring without looking, the user will typically use his or her thumb and forefinger to scan the surfaces of each key for identifiable characteristics until the correct key is located. This process of elimination can be difficult when keys are of similar size and shape. As shown in the figure, the distinctive shape of indentation 20 allow a user to identify key 10 merely by touch. In alternative embodiments of the present invention, key head 16 may include other bordered indented portions in addition to, or in lieu of, indentation 20. Moreover, in other alternative embodiments of the present invention, indentation 20 may manufactured to include physically identifiable features integrally formed in indentation 20, such as ribs, textured portions, and indicia. As such, key 10 may be manufactured with a variety of designs for key head 16.

In addition to physically distinct designs, key head 16 may also include visually distinct ornamentations, such as adhesive or printed labels that contain indicia, colors, or images. As shown in the figure, indentation 20 contains label 22, which includes indicia to visually identify key 10 as a key for a front door. The deep protective border of indentation 20 protects label 22 from prematurely peeling or wearing. The use of label 22 is particularly suitable when key 10 is occasionally or rarely used, and a user may forget which lock key 10 corresponds to.

The designs of key 10 also allow jewelers, artists, or craftspeople to become designers and manufacturers of key 10. As such, key head 16 of key 10 may be designed for specific and individual uses (e.g., ergonomics and identification). Additionally, such users may also design key 10 to accept one of many forms of fixed ornamentation such as leather, wood, plastic, precious alloys, stones, stamped relief art, epoxy domed logos, low heat enamels, and combinations thereof. This further increases the versatility of key 10.

In addition to acceptable machinabilities, the alloys of key 10 also exhibit good tensile strengths. Examples of suitable ultimate tensile strengths for the alloy of key 10 include at least about 70,000 pounds/inch² (psi) as cast. Examples of suitable tensile yield strengths for the alloy of key 10 include at least about 25,000 psi as cast. For example, UNS C95200 exhibits an ultimate tensile strength of about 80,000 psi as cast, and a tensile yield strength of about 27,000 psi as cast. Similarly, UNS C95300 exhibits an ultimate tensile strength of about 80,000 psi TQ50 temper, and a tensile yield strength of about 40,000 psi TQ50 temper. The physical properties of UNS C95200 and C95300 are measured pursuant to ASTM B148-03. The good tensile strengths provide key 10 with high durability during use. This is particularly useful for keys to prevent accidental breakage within a lock.

Key 10 of the present invention provides for use of safe alloys manufactured with designs that are ergonomical, identifiable, and are ornamental. A variety of entities may design, manufacture, and market their own personalized designs for key head 16. Such designs may be based on a selection of the most popular residential, commercial, and automotive keys that could be marketed by new and non-traditional key duplicating settings, such as jewelry stores, art fairs, craft shows, and flea markets.

Although the present invention has been described with reference to preferred embodiments, workers skilled in the art will recognize that changes may be made in form and detail without departing from the spirit and scope of the invention.

1. A key comprising a key head and a key blade, the key blade being connected to the key head, wherein the key head and the key blade are each manufactured from an alloy that comprises at least about 70% by weight copper, and wherein the alloy includes less than about 6.0% by weight nickel and is substantially free of lead.

2. The key of claim 1, wherein the alloy includes less than about 3.0% by weight nickel.

3. The key of claim 2, wherein the alloy includes less than about 0.5% by weight nickel.

4. The key of claim 1, wherein the alloy further comprises aluminum, and wherein the aluminum constitutes about 5% to about 15% by weight of the alloy.

5. The key of claim 1, wherein the alloy further comprises silicon, and wherein the silicon constitutes about 1.5% to about 3.5% by weight of the alloy.

6. The key of claim 1, wherein the alloy further comprises iron, and wherein the iron constitutes about 0.5% to about 6% by weight of the alloy.

7. The key of claim 1, wherein the copper constitutes at least about 80% by weight of the alloy.

8. The key of claim 8, wherein the alloy exhibits an ultimate tensile strength of at least about 70,000 pounds-per-square inch.

9. The key of claim 1, wherein the key head has a first major surface and a second major surface, wherein the first major surface includes a bordered indented portion.

10. The key of claim 9, wherein the key head comprises a label disposed on the bordered indented portion.

11. The key of claim 1, wherein the key blade is integrally connected to the key head.

12. A key comprising a key head and a key blade, the key blade being connected to the key head, wherein the key head and the key blade are each manufactured from an alloy that comprises copper, aluminum, and silicon, and wherein the alloy includes less than about 6.0% by weight nickel and is substantially free of lead.

13. The key of claim 12, wherein the alloy includes less than about 3.0% by weight nickel.

14. The key of claim 13, wherein the alloy includes less than about 0.5% by weight nickel.

15. The key of claim 12, wherein the aluminum constitutes about 6% to about 8% by weight of the alloy.

16. The key of claim 12, wherein the copper constitutes at least about 80% by weight of the alloy.

17. A method of manufacturing a key, the method comprising:
providing a mold of the key, wherein the mold dimensionally defines a key head and a key blade of the key;
inserting an alloy into the mold, wherein the alloy comprises at least about 70% by weight copper, and wherein the alloy includes less than about 6.0% by weight nickel and is substantially free of lead; and
allowing the alloy to substantially cool in the mold to form the key having the key head and the key blade, wherein the key blade is integrally connected to the key head.

18. The method of claim 17, wherein the alloy includes less than about 3.0% by weight nickel.

19. The method of claim 12, wherein the copper constitutes at least about 86% by weight of the alloy, the aluminum constitutes about 6% to about 8% by weight of the alloy, and the silicon constitutes about 1.5% to about 3.5% by weight of the alloy.

20. The method of claim 17, wherein the mold further dimensionally defines a bordered indented portion on a first major surface of the key head.
